(19) United States
(12) Patent Application Publication
(10) Pub. No.: US 2005/0126835 A1
(43) Pub. Date: Jun. 16, 2005

(54) Self propelled gurney and related structure confidential and proprietary document

(76) Inventor: Thomas E. Lenkman, St. Charles, MO (US)

Correspondence Address: Henry W. Cummings, 3313 W. Adams St., St. Charles, MO, 63301, US

(21) Appl. No.: 10/735,779

(22) Filed: Dec. 16, 2003

(51) Int. Cl. B60K 1/00

(52) U.S. Cl. 180/65.1

(57) ABSTRACT

The present invention comprises a series of modules, including a control/handle module, a cord reel/charger module, a drive module, and a chassis assembly, plus all needed electrical wiring harnesses and pneumatic tubing to connect them. Also included are means to mount the modules to any existing gurney and to each other without making permanent modifications to the gurney. The gurney is controlled by a handle assembly containing all necessary controls and indicators to allow the operator to select forward or reverse direction, increase or reduce speed of travel, observe the state of battery charge, and energize or deenergize power from the various modules. In addition, the handle may be swung down through 180 degrees to facilitate loading and unloading the gurney.

### I FIELD OF THE INVENTION

This invention relates to self-propelled hospital equipment, specifically gurneys.

### II BACKGROUND OF THE INVENTION

Modular hospital gurneys are large, heavy pieces of equipment having a plurality of free castering wheels. When occupied by a patient, a gurney becomes extremely heavy and cumbersome to control, particularly on slanted or uneven surfaces. Directional control of gurneys has been improved in the past by the introduction of a small, unpowered, non-castering wheel in the center of the unit. This reduces the tendency of the gurney to move in random directions due to its castering wheels. However, the gurney is still large and very heavy when occupied, necessitating its operation by two or more people. Even so, there is still a risk of back or other personal injury on the part of the operators.

Motorizing the gurney allows it to be easily handled by one person, and dramatically reduces the risk of personal injury on the part of the operator. Other motorized gurneys are in use, but they are purpose-built as powered units, which increases the cost. The present invention comprises modular units which can easily be mounted on any existing gurney, motorizing it.

U.S. Patent Application 20020043411 discloses a stretcher having a motorized wheel. This invention comprises a purpose-built gurney with an integral motor drive unit.

U.S. Patent Application 20030024048 discloses a patient-support apparatus having grippable handle. This invention is similar to that disclosed in U.S. Patent Application 20020043411, but lacking a motor drive unit.

### III SUMMARY OF THE INVENTION

### A. Objects of the Invention

One object of the present invention is to provide a modular apparatus for converting a common hospital gurney to a self-propelled unit.

Another object of the present invention is to provide modular units which will easily and quickly mount to any gurney without need of modifying said gurney.

Another object of the present invention is to provide modular units which can be transferred to another gurney with a minimum of effort.

### B. Summary

The present invention comprises a series of modules, including a control/handle module, a cord reel/charger module, a drive module, and a chassis assembly, plus all needed electrical wiring harnesses and pneumatic tubing to connect them. Also included are means to mount the modules to any existing gurney and to each other without making permanent modifications to the gurney. The gurney is controlled by a handle assembly containing all necessary controls and indicators to allow the operator to select forward or reverse direction, increase or reduce speed of travel, observe the state of battery charge, and energize or deenergize power from the various modules. In addition, the handle may be swung down through 180 degrees to facilitate loading and unloading the gurney.

Rechargable batteries of sufficient voltage are contained within the chassis assembly of the present invention. They provide all electrical power, and may be recharged using a self-contained charger assembly by means of a retractable AC power cord.

A small, internally driven wheel provides the means to move the gurney. The wheel is part of a drive unit which swivels up when electrical power is removed, allowing the gurney to be moved manually.

When power is applied, the drive unit swivels down by means of a pneumatically actuated air spring that provides sufficient pressure on the floor to afford traction to the drive wheel. The drive unit also compensates for irregularities in the floor surface, such as a ramp, by increasing the air pressure in the air spring and forcing the drive unit farther down.

### IV. THE DRAWINGS

FIG. 1 is an exploded perspective view showing modules of the present invention.

FIG. 2 is a perspective view of the control/handle module of the present invention, showing it mounted on a gurney in the normal position.

FIG. 3 is a side view of the control/handle module of the present invention, showing it in the folded down position.

FIG. 4 is a perspective view showing the remaining modules of the present invention installed in a gurney.

FIG. 5A is a perspective view of the cord reel/charger module of the present invention.

FIG. 5B is a perspective detail view of the cord reel/charger module of the present invention from the opposite side, looking in the direction of arrows 5B-5B in FIG. 5A.

FIG. 6 is an exploded view of the drive module of the present invention.

FIG. 7 is a partially exploded perspective view of the chassis of the present invention.

FIG. 8 is a side view of a gurney's brake pedal arrangement detailing how the electric and pneumatic switches are actuated.

FIG. 9A is a side view showing the present invention in its retracted position.

FIG. 9B is a side view showing the present invention in its engaged position on a normal floor surface.

FIG. 10 is a side view showing the present invention in its engaged position on an irregular floor surface.

### V. DESCRIPTION OF PREFERRED EMBODIMENTS

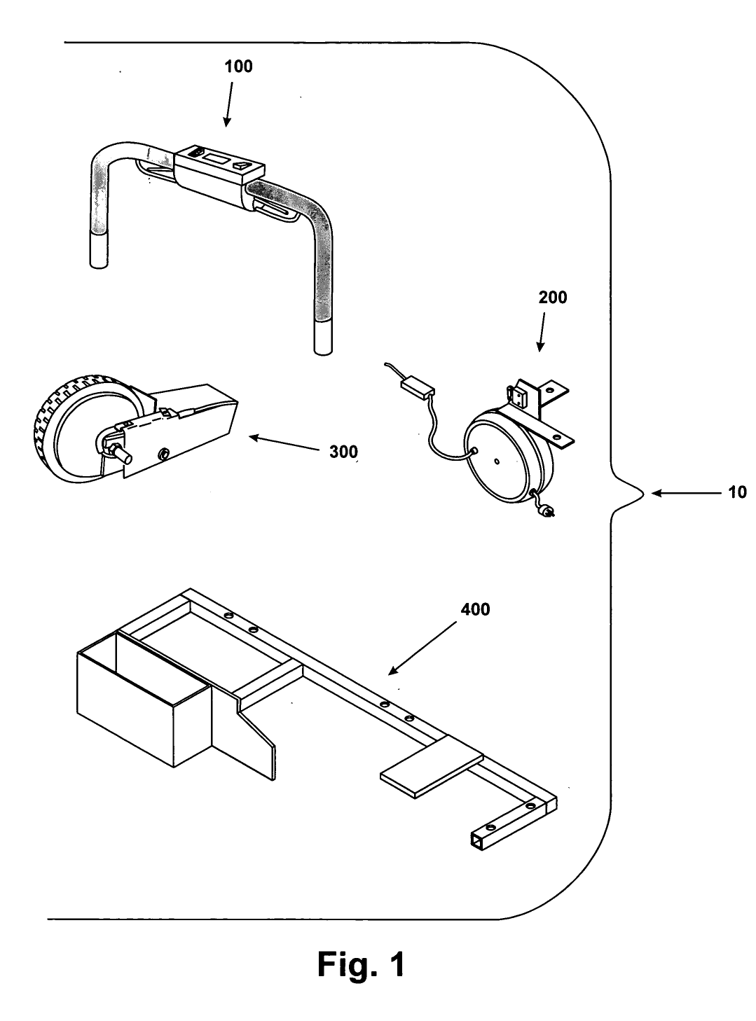

In accordance with the present invention, FIG. 1 shows the present invention generally at 10, which comprises control/handle module 100, cord reel/charger module 200, drive module 300, and chassis assembly 400.

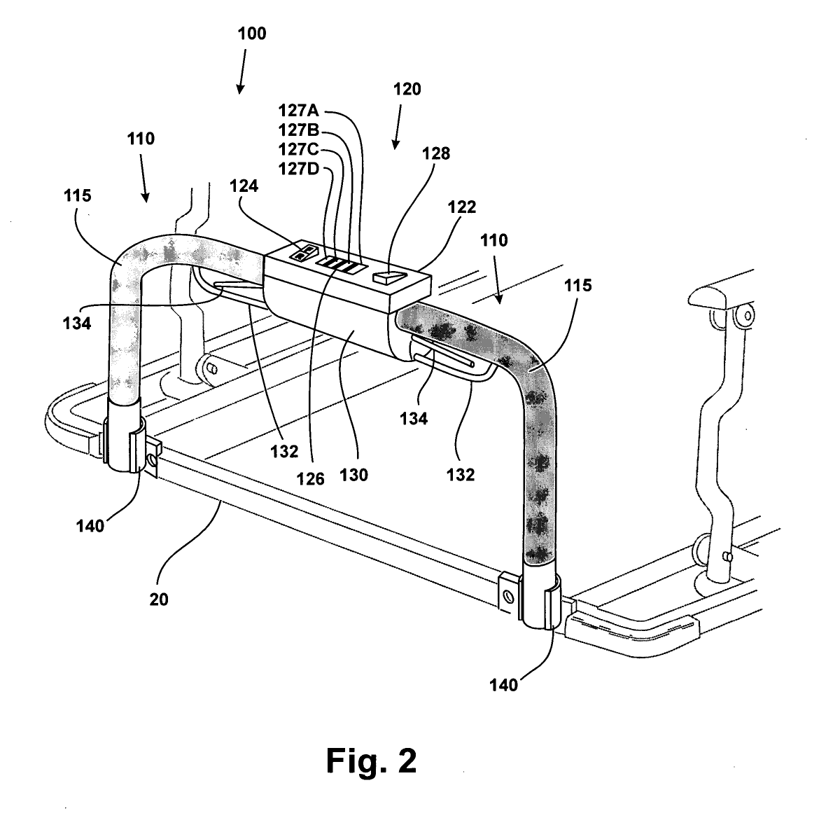

FIG. 2 shows control/handle module 100 in the normal position, mounted to a gurney 20 using mounting means 140. Handles 110 are made of steel, aluminum, carbon fiber, or other suitable material. Handles 110 are covered with a rubberized elastomeric substance 115, such as providing a non-slip grip for the operator.

Control assembly 120 is mounted to handles 110, is made of steel, aluminum, plastic or other suitable material, and comprises upper housing 122 and lower housing 130. Upper housing 122 contains directional switch 124, battery charge indicator 126, and on/off switch 128. Lower housing 130 contains throttle levers 134 and guards 132.

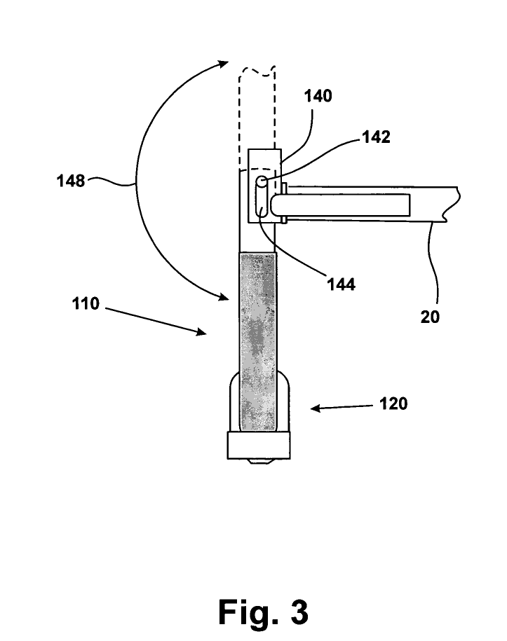

FIG. 3 shows handles 110 in their down position. This position is provided to easily load or unload a patient from gurney 20. To move to the down position, the operator lifts straight up on handles 110, causing pivot 142 to move up in slot 144. This frees handles 110 from mounting means 140, and permits swinging it down through 180 degree angle 148.

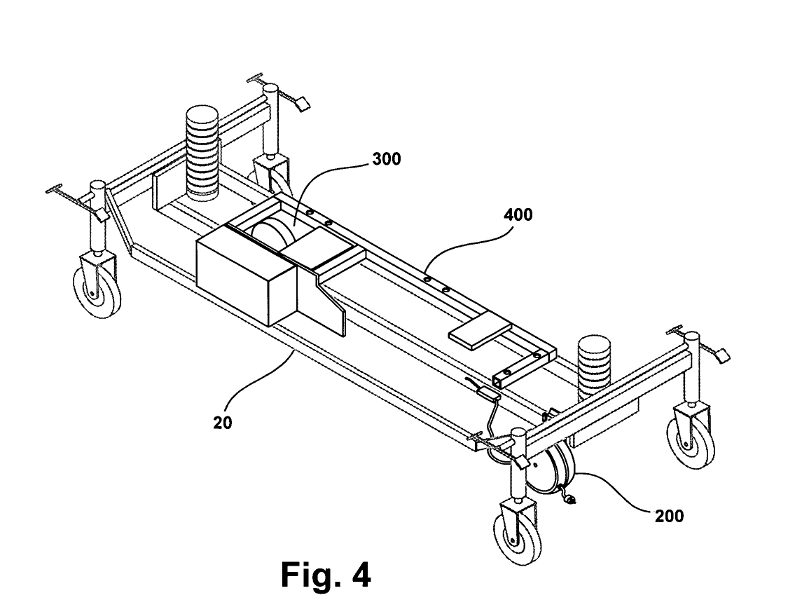

FIG. 4 shows additional modules of the present invention (cord reel/charger module 200, drive module 300, and chassis assembly 400) mounted to a generic gurney 20 chassis. The bed portion of the gurney is not shown for clarity.

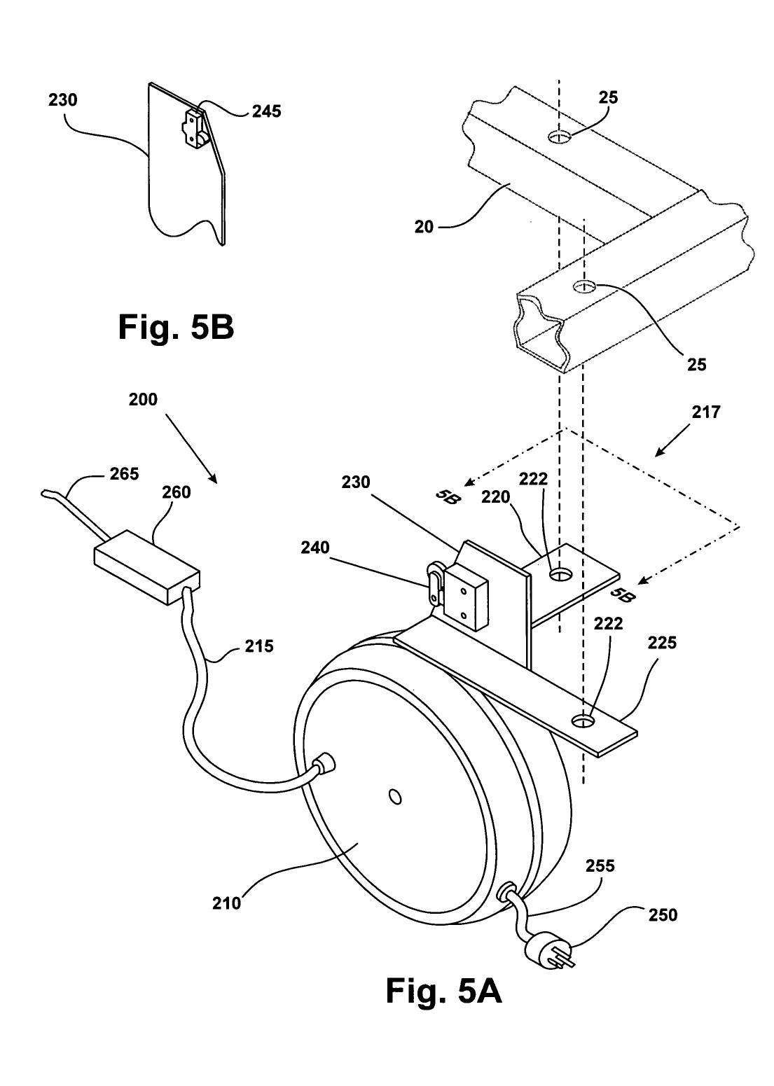

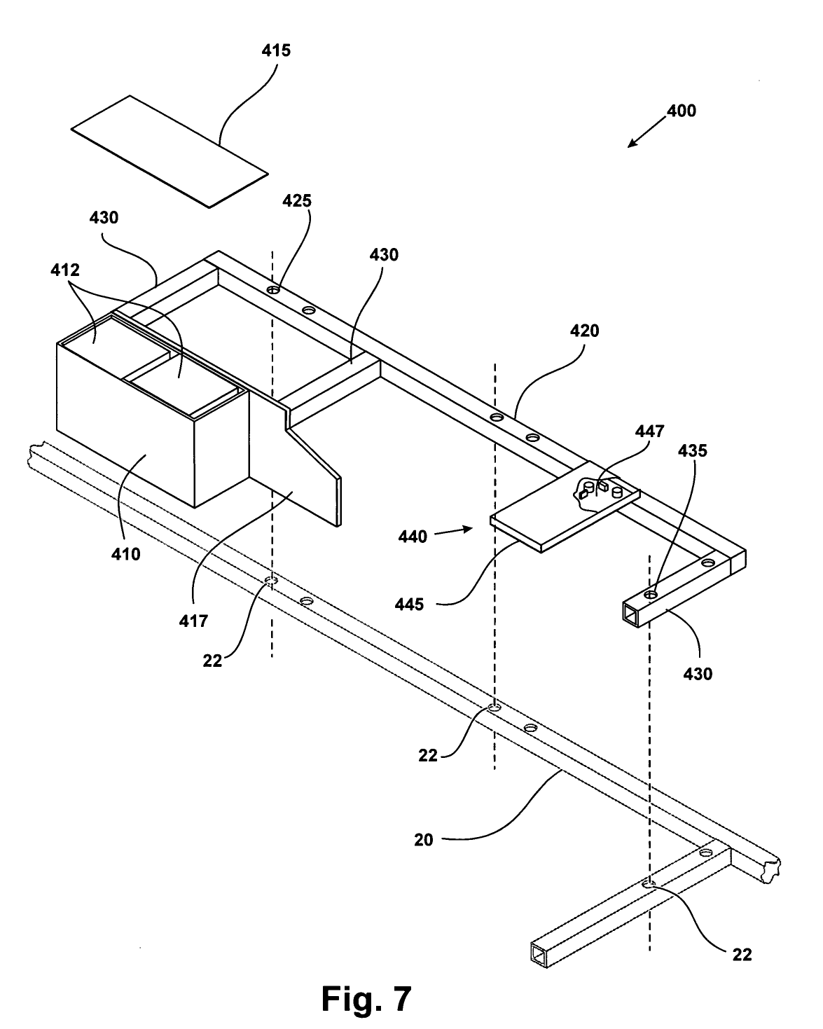

FIG. 5A shows cord reel/charger module 200. A commercially available retractable cord reel comprises reel enclosure 210, cord 215, cord 255, and plug 250. Cord 215 is connected to charger 260, a commercially available unit which may be manufactured by Chargetek, or other suitable vendor. Cord 265 is routed to batteries 412 (FIG. 7). Reel enclosure 210 is mounted to reel mount 217, which is made of steel, aluminum, carbon fiber, or other suitable material and comprises longitudinal support 225, lateral support 220, and switch bracket 230. Pneumatic interlock switch 240 is shown mounted to switch bracket 230. Cord reel/charger module 200 is mounted to existing holes 25 on gurney 20 using mounting holes 222.

In FIG. 5B, switch bracket 230 is shown from the opposite side, along with electric interlock switch 245.

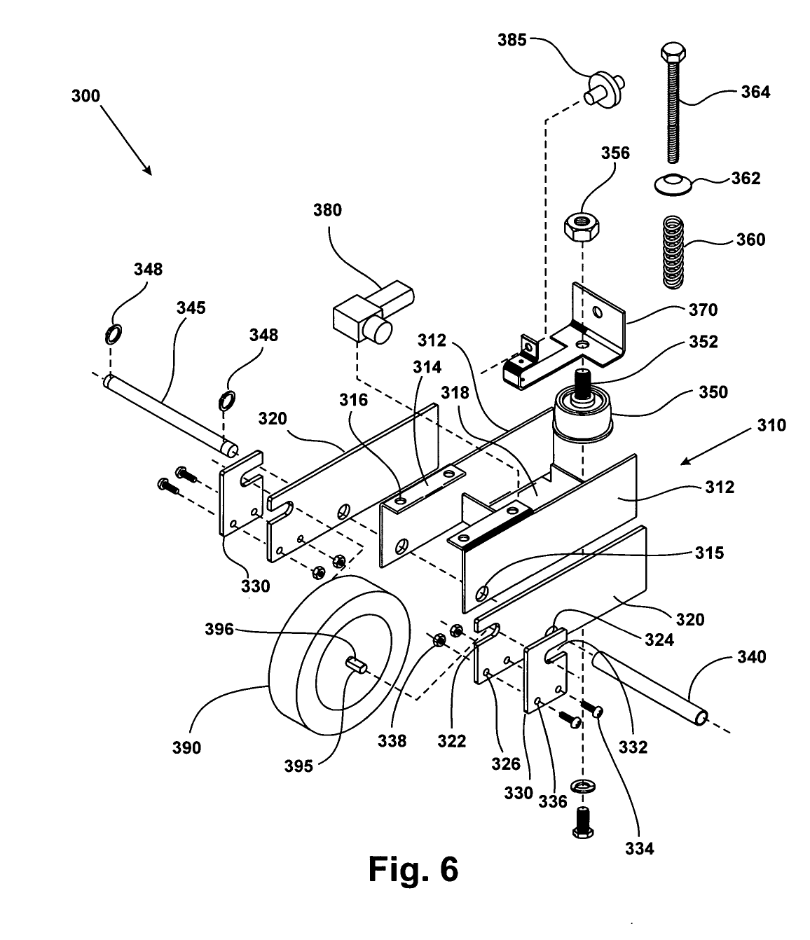

FIG. 6 shows an exploded view of drive module 300. Drive housing 310 is made of steel, aluminum, carbon fiber, or other suitable material and comprises sides 312, mounting flanges 314, and bottom 318. All components of drive module 300 mount to drive housing 310, which in turn is mounted to gurney 20 via mounting holes 316. Pivot arms 320 are attached to drive housing 310 via spacer 340 and pivot axle 345 passing through pivot arm shaft holes 315 and 324. These assemblies are secured by spring clips 348.

Drive wheel 390 is manufactured by Assembled Products under the trade name of Hubmotor. Drive wheel 390 comprises a motor, a gear drive, and a solid rubber tire, negating the need for external components. Any other similar drive wheel meeting the requirements of the present invention may be used. Axles 395 of drive wheel 390 have flats 396, and fit into slots 322 of pivot arms 320. Lock plates 330 are mounted on pivot arms 320 via holes 326 and 336 by screws 334 and nuts 338. The flat sides of slots 322 and 332 fit the flats 396 of drive wheel 390 axles 395, preventing axles 395 from turning.

Air spring 350 is manufactured by Enidine or any suitable vendor, and is mounted to upper plate 370 by means of air spring inlet 352 and nut 356, and to drive housing 310 by means of bolt 354 and washer 358. Air pressure switch 385 is also mounted to upper plate 370. Air pressure switch 385 controls when air compressor 380 is activated, and is used to control the air pressure present in air spring 350, and thus the extent of its travel. Air pressure switch 385 may be adjusted to provide optimum wheel traction. Coil spring 360 is mounted to drive housing 310 by means of screw 364 and cap 362.

Air compressor 380 is manufactured by Thomas or other suitable vendor and is mounted into drive housing 310.

FIG. 7 shows chassis assembly 400, which is made of steel, aluminum, carbon fiber, or other suitable material. Chassis assembly 400 comprises battery box 410, battery box cover 415, battery box support 417, longitudinal member 420, and lateral members 430. Battery box 410 holds two commercially available, rechargable, 12-volt batteries 412. Battery box cover 415 reduces the possibility of water or other contaminants entering battery box 410. Chassis assembly 400 is mounted directly to any gurney 20 by means of mounting holes 425, 435, which are positioned to correspond with existing holes 22 in gurney 20. This eliminates the need to drill mounting holes in gurney 20.

Chassis assembly 400 also comprises control circuit board assembly 440, comprising circuit board 447 and circuit board cover 445. Circuit board 447 is a commercially available device, which may be manufactured by Rosstron, for example.

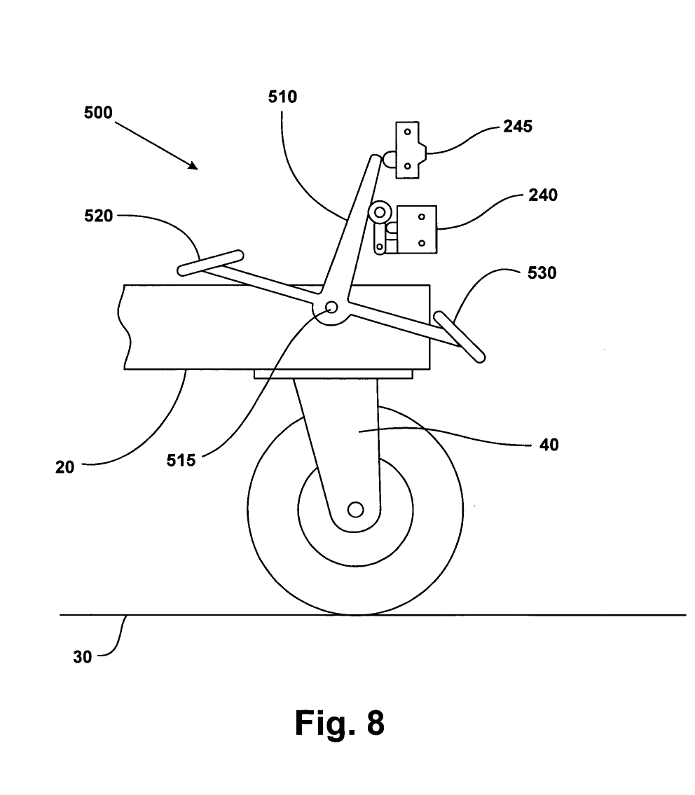

FIG. 8 is a side view of how the existing foot controls 500 of gurney 20 interact with electrical and pneumatic circuitry of the present invention. The exact details of switch actuation may vary from one gurney design to another. Red brake pedal 520 and green release pedal 530 are mounted to actuator arm 510, which is mounted to gurney 20 by means of pivot axle 515. When depressed, green release pedal 530 allows free movement of caster/wheel assembly 40. In addition, actuator arm 510 contacts pneumatic interlock switch 240 and electric interlock switch 245, allowing pneumatic and electric power to be routed to their respective destinations. Conversely, depressing red brake pedal 520 locks caster/wheel assembly 40, while removing contact from pneumatic interlock switch 240 and electric interlock switch 245, removing pneumatic and electric power from their respective destinations.

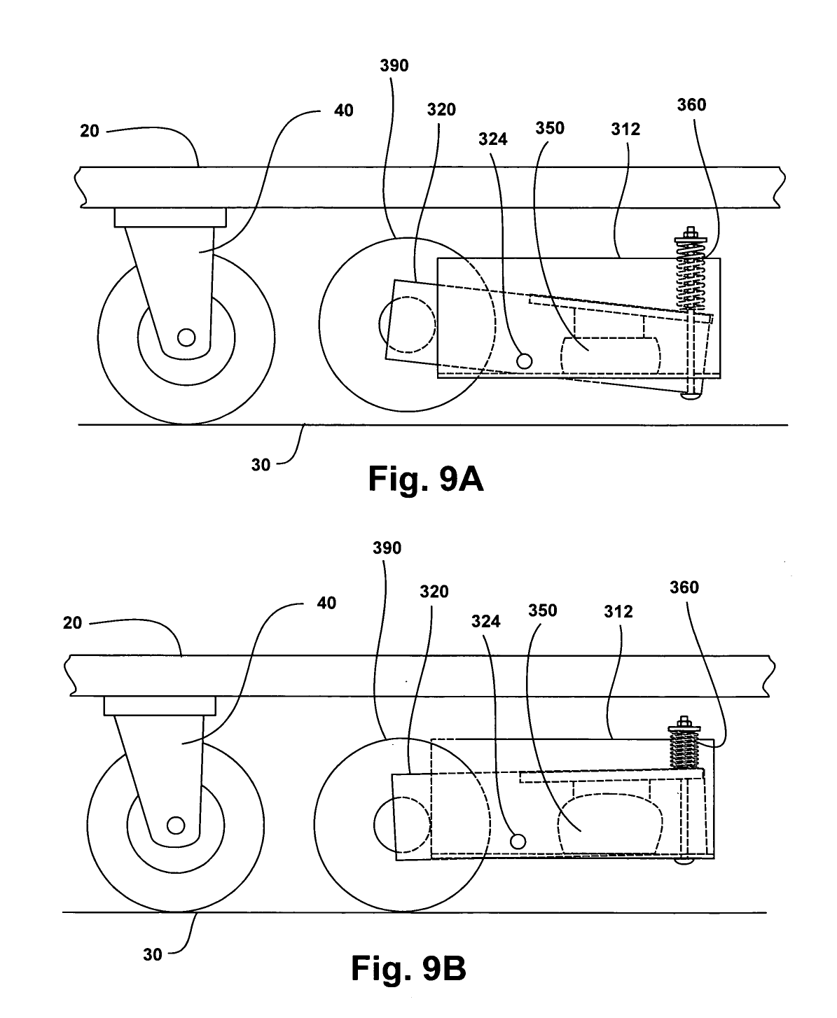

FIG. 9A shows a side view of the present invention in its retracted position. Air spring 350 is deflated, allowing pivot arms 320 to swivel up around pivot arm shaft hole 324 due to pressure from coil spring 360. This lifts drive wheel 390 up from floor 30 and allows manual operation of gurney 20.

FIG. 9B shows a side view of the present invention in its extended position. Air spring 350 is inflated, causing pivot arms 320 to swivel down around pivot arm shaft hole 324 against pressure from coil spring 360. This forces drive wheel 390 down against floor 30, permitting self-propelled operation of gurney 20.

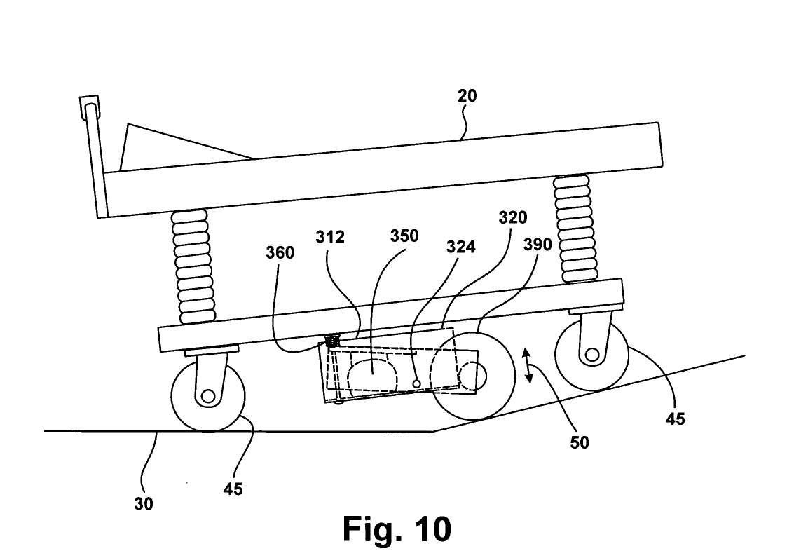

FIG. 10 shows shows a side view of the present invention in its extended position on a slanted floor 30. Air spring 350 inflates to a greater extent, causing pivot arms 320 to swivel farther down around pivot arm shaft hole 324 against pressure from coil spring 360. This forces drive wheel 390 down against floor 30, permitting self-propelled operation of gurney 20 on an uneven surface.

In the self-propelled mode, an operator first steps on green release pedal 530 (FIG. 8), releasing the brakes of gurney 20 and actuating pneumatic interlock switch 240 and electric interlock switch 245. Electric interlock switch 245 completes an electrical circuit, energizing the controls in control/handle module 100 (FIG. 2), as well as all other electrical circuitry. Pneumatic interlock switch 240 (FIG. 8) completes a pneumatic circuit, allowing compressor 380 (FIG. 6) to provide compressed air to air spring 350 via air pressure switch 385.

The operator turns on/off switch 128 (FIG. 2) to the ON position, energizing compressor 380 (FIG. 6) which provides compressed air to air spring 350 via air pressure switch 385. Drive wheel 390 is forced down against floor 30 as shown in FIG. 9B. When drive wheel 390 contacts floor 30 with sufficient force to provide motive power to gurney 20, air pressure switch 385 (FIG. 6) removes electrical power from compressor 380. The drive wheel is now in position for self-propelled operation.

The operator selects the desired direction of travel using direction switch 124 (FIG. 2). The operator squeezes one or both throttles 134, which provide variable electrical power to drive wheel 390 (FIG. 6) via control circuit board 447(FIG. 7). Gurney 20 now moves under its own power, allowing the operator absolute control of its speed and direction of motion. If drive wheel 390 travels over a slanted floor, such as a ramp, as shown in FIG. 10, there is less pressure on air spring 350. Pressure switch 385 (FIG. 6) senses this reduced pressure, and energizes compressor 380, which supplies more air to air spring 350, keeping drive wheel 390 in contact with floor 30 (FIG. 10). If the level of floor 30 rises, causing more air pressure inside air spring 350 (FIG. 10), this condition is sensed by pressure switch 385 (FIG. 6), which releases the excess pressure. The net result is that drive wheel 390 exerts the same force on floor 30 regardless of its level relative to gurney 20.

Releasing throttles 134 (FIG. 2) de-energizes drive wheel 390 (FIG. 6), causing gurney 20 to stop. As long as drive wheel 390 is in contact with floor 30, gurney 20 is inhibited from moving, but will not be locked into place until the operator actuates red brake pedal 520 (FIG. 8). So doing sets the brakes on all wheel/caster assemblies 40 and removes electrical and pneumatic power from all components of the present invention. Once pneumatic pressure is removed from air spring 350, it deflates, allowing drive wheel 390 to raise up from floor 30 (FIG. 9A). At this point, the operator should turn on/off switch 128 (FIG. 2) to the OFF position. In the event the operator forgets to turn on/off switch 128 off, built-in circuitry removes all electrical power after a preset time delay. This reduces the possibility of discharging the batteries through neglect.

Battery charge indicator 126 (FIG. 2) comprises a series of lights 127A, 127B, 127C, 127D to indicate the state of the battery charge. The fewer lights lit, the more discharged are the batteries. To charge the batteries, the operator pulls plug 250 (FIG. 5A) from reel enclosure 210 and inserts it into any convenient wall receptacle. Charger 260 provides power to batteries 410 (FIG. 7) until they are fully charged.

1. A modular drive unit for a gurney comprising:
A control/handle module,
A cord charger module,
A drive module,
A chassis assembly,
Electrical wiring harnesses,
Pneumatic tubing, and
Mounting means.

2. A modular drive unit for a gurney according to claim 1 having a control/handle module to provide means for maintaining directional and speed control over said gurney.

3. A modular drive unit for a gurney according to claim 2 wherein said control/handle module may be swung 180 degrees down from the operating position in order to facilitate loading or unloading said gurney.

4. A modular drive unit for a hospital gurney according to claim 2 wherein said control/handle module utilizes a coating on the handle to afford a non-slip grip for the operator.

5. A modular drive unit for a gurney according to claim 2 wherein at least one control/handle module contains all necessary means for a single operator to control a gurney's speed and direction of travel.

6. A modular drive unit for a gurney according to claim 1 having a cord charger module to provide means to recharge batteries.

7. A modular drive unit for a gurney according to claim 6 wherein said cord charger module mainly comprises at least one cord reel.

8. A modular drive unit for a gurney according to claim 7 wherein said cord charger module contains mounting means to secure it to said gurney.

9. A modular drive unit for a gurney according to claim 6 wherin said cord charger module contains mounting means for interlock switches selected from hydraulic, electrical mechanical and pneumatic interlock switches which interact with standard linkages common to said gurney.

10. A modular drive unit for a gurney according to claim 9 wherein said interlock switches control the presence or absence of electrical power and air pressure to said modular unit.

11. A modular drive unit for a gurney according to claim 1 having a drive module which retractably contacts a floor surface and provides means to propel said gurney in any selected direction and speed.

12. A modular drive unit for a gurney according to claim 11 wherein said drive module comprises a drive wheel having a self-contained electric motor, gear, and tire unit which will move forward and reverse at variable speeds.

13. A modular drive unit for a gurney according to claim 11 wherein said drive module comprises a pneumatic air spring which forces said drive wheel in sufficient contact with a floor to avoid slippage.

14. A modular drive unit for a gurney according to claim 11 wherein said drive module comprises an air compressor and pressure switch to maintain the inflation level of said air spring, irrespective of the relative distance between the floor surface and the gurney chassis, causing said drive wheel to exert the same force on the floor.

15. A modular drive unit for a gurney according to claim 11 wherein said drive module comprises a lock plate arrangement to adjustably capture the axles of said drive wheel in order to maintain its position relative to the rest of the drive module, and to prevent rotation of said axles.

16. A modular drive unit for a gurney according to claim 1 having a chassis assembly containing a battery box, a control circuit board assembly, and means to mount said drive module.

17. A modular drive unit for a gurney according to claim 16 wherein said chassis assembly is designed to mount to the frame of an existing gurney without modifying said gurney.

18. A modular drive unit for a gurney according to claim 16 wherein said battery box provides space forat least one rechargeable battery and contains a cover to reduce the possibility of water or other contaminants entering said battery box.

19. A modular drive unit for a gurney according to claim 16 wherein said control circuit board assembly provides an interface between said control/handle module and said drive module.

20. A modular drive unit for a gurney according to claim 1 containing electrical wiring harnesses which provide all necessary electrical power and feature quick-disconnect fasteners for ease of installation, maintenance, and battery replacement.

21. A modular drive unit for a gurney according to claim 1 containing pneumatic tubing which provide all necessary air pressure and feature quick-disconnect fasteners for ease of installation and maintenance.

22. A modular drive unit for a gurney according to claim 1 containing mounting means to attach modules to each other and to the host gurney, said mounting means including but not be limited to: screws, bolts, nuts, washers, lock washers, and nylon tie wraps.

23. A gurney control system comprising a handle, a mounting system, and a control system.

24. A gurney control system according to claim 23 wherein said handle may be made from a material selected from steel, aluminum, and carbon fiber and is partially covered with a material to provide a slip-resistant gripping surface.

25. A gurney control system according to claim 23 wherein said handle provides means of controlling the speed and direction of movement of said gurney as well as providing a mounting means for the control assembly.

26. A gurney control system according to claim 23 wherein said mounting system comprises means to secure said handle to the gurney, means to lock said handle in the upright position, and means to allow said handle to swing down through 180 degrees to facilitate loading and unloading the gurney.

27. A gurney control system according to claim 26 wherein said securing means may be made of a material selected from steel, aluminum, carbon fiber and is mounted to said gurney using existing holes in the gurney; said securing means comprising mechanical fasteners including an appropriate combination of screws, nuts, bolts, and washers.

28. A gurney control system according to claim 26 wherein said means to lock said handle in the upright position comprises a socket into which the handle is held by gravity.

29. A gurney control system according to claim 26 wherein said swinging means comprise pivot pins mounted to said handles which ride in slots in the sides of the mounting means.

30. A gurney control system according to claim 23 wherein said control assembly comprises a housing containing controlling means.

31. A gurney control system according to claim 30 wherein said housing is made from a material selected from steel, aluminum, plastic, and carbon fiber.

32. A gurney control system according to claim 31 wherein said housing is mounted to said handle and comprises an upper housing and a lower housing; said upper housing comprises an on/off switch, a directional switch, and a battery charge indicator; said lower housing contains speed control throttles and throttle guards.

33. A gurney control system according to claim 32 wherein said on/off switch provides means to energize or de-energize all electrical components of the gurney electrical system.

34. A gurney control system according to claim 32 wherein said on/off switch is selected from a rocker, rotary, and a toggle switch.

35. A gurney control system according to claim 31 wherein said directional switch provides means to select the direction in which the gurney moves.

36. A gurney control system according to claim 31 wherein said directional switch is selected from may be a rocker, rotary, or toggle switch type.

37. A gurney control system according to claim 31 wherein said battery charge indicator contains means for indicating the state of the battery charge.

38. A gurney control system according to claim 37 wherein said means for indicating the state of the battery charge is selected from a light emitting diode (LED), a liquid crystal display (LCD), and at least one incandescent lamp that indicates the state of the battery charge.

39. A gurney control system according to claim 31 wherein said speed control throttles provide variable voltage and current to the drive unit, allowing the gurney to travel at variable speed.

40. A gurney control system according to claim 31 wherein said speed control throttles may be moved to multiple positions to provide variable voltage and current to the drive unit, allowing the gurney to travel at variable speed.

41. A gurney control system according to claim 39 wherein one speed control throttle is mounted on each side of said lower housing assembly, allowing the user to operate either handle to vary the speed of the gurney.

42. A gurney control system according to claim 31 wherein one throttle guard is mounted on each side of the lower housing, and is positioned so as to reduce the possibility of accidental actuation of said speed control throttles.

43. A gurney control system according to claim 42 wherein said throttle gaurds are made from a material selected from steel, aluminum, and plastic.

44. A cord reel/charger assembly comprising:
a cord reel;
means for mounting said cord on a gurney;
and a charger assembly.

45. A cord reel/charger assembly according to claim 44 wherein said assembly includes a cord reel electrical cords, and a housing.

46. A cord reel/charger assembly according to claim 45 wherein said electrical cords comprise an input cord and output cord.

47. A cord reel/charger assembly according to claim 46 wherein said input cord is terminated by a common grounded male electrical plug.

48. A cord reel/charger assembly according to claim 46 wherein said input cord is wound around said enclosed, spring-loaded reel, whereby when in use, said input cord may be pulled from said spring-loaded reel until sufficient length is obtained to reach a nearby wall socket, and after use, said input cord is allowed to retract into the housing by means of the spring-loaded reel.

49. A cord reel/charger assembly according to claim 44 wherein said output cord is not retractable, but is instead fixed on the side of said enclosure, and is of sufficient length to reach the charger assembly.

50. A cord reel/charger assembly according to claim 44 wherein said housing provides a safe enclosure for said electrical cords and spring-loaded reel.

51. A cord reel/charger assembly according to claim 50 wherein said spring-loaded reel contains a length of electrical cord sufficient to reach a nearby wall mounted socket, and provides for easy extension and retracting of said electrical cord.

52. A cord reel/charger assembly according to claim 44 wherein said mounting means are secured to said cord reel, and in turn are secured to existing holes in the gurney using common mechanical fasteners.

53. A cord reel/charger assembly according to claim 44 wherein said charger assembly is a commercially available unit comprising a housing, charging circuitry, and wherein said housing protects said charging circuitry from water or other foreign damage, and prevents outside contact with said charging circuitry in order to prevent personal injury.

54. A cord reel/charger assembly according to claim 53 wherein said charging circuitry receives electrical power via said cord reel, and converts it to an appropriate voltage to charge batteries.

55. A cord reel/charger assembly according to claim 52 wherein said mounting means secure said charger assembly to the gurney.

56. A drive module system comprising;
a housing;
a drive wheel assembly;
an air spring;
an air compressor;
a pressure switch;
means for pivoting;
means for mounting, and
an interlock system.

57. A drive module system according to claim 56 wherein said housing includes a cover to protect its components from water or other foreign matter contamination.

58. A drive module system according to claim 56 wherein said drive wheel assembly is a self-contained unit having axles, a tire, an internal electric motor, internal gearing, and means for braking.

59. A drive module system according to claim 57 wherein said housing and said cover are made from a material selected from steel, aluminum, and carbon fiber.

59. A drive module system according to claim 56 wherein said drive wheel assembly is a self-contained unit having axles, a rubber tire, an internal electric motor, and internal gearing.

60. A drive module system according to claim 59 wherein said axles are round with flat sides and provide means to secure said drive wheel assembly.

61. A drive module system according to claim 59 wherein said tire provides sufficient traction to move the gurney.

62. A drive module system according to claim 59 wherein said internal electric motor is energized by variable voltage, and may run in forward or reverse, depending upon the polarity of the applied voltage.

63. A drive module system according to claim 59 wherein said internal gearing transfers rotational motion from the motor to said tire.

64. A drive module system according to claim 56 wherein said air spring will increase its size when air pressure is applied, and decrease when said air pressure is removed.

65. A drive module system according to claim 56 wherein said air compressor provides sufficient air pressure to inflate said air spring when electrical power is supplied to said air compressor.

66. A drive module system according to claim 56 wherein said pressure switch includes at least one preset air pressure setpoint, and is an adjustable unit capable of controlling the electrical power supplied to said air compressor and turning it on or off based on said preset air pressure setpoint.

67. A drive module system according to claim 66 wherein said pressure switch senses the air pressure in the air spring, and maintains it said preset air pressure setpoint, whereby substantial contact is maintaining contact between said the drive wheel and the floor surface.

68. A drive module system according to claim 56 wherein said means for pivoting comprise pivot arms, a pivot axle, means for mounting said drive wheel, and a resilient spring means.

69. A drive module system according to claim 68 wherein said pivot arms are made from a material selected from steel, aluminum, and carbon fiber.

70. A drive module system according to claim 69 wherein said pivot arms swing up and down based on the air pressure present in said air spring, allowing said drive wheel to either raise up from or contact the floor to provide drive power.

71. A drive module system according to claim 68 wherein said pivot axle connects said pivot arms to said housing, and provides means for said pivot arms to freely swing up and down.

72. A drive module system according to claim 68 wherein said means for mounting drive wheel comprise lock plates and slots cut into said pivot arms and said lock plates.

73. A drive module system according to claim 72 wherein said slots in said lock plates and said pivot arms have straight sides that capture the flats of said axles, thereby preventing said axles from turning.

74. A drive module system according to claim 68 wherein said resilient spring means provides means to maintain said drive wheel and said pivoting means in the retracted position when air pressure is removed from said air spring.

75. A drive module system according to claim 56 wherein said mounting means comprise surfaces containing holes which correspond to holes in the chassis assembly, and mechanical fasteners.

76. A drive module system according to claim 56 wherein said interlock system interlock switches selected from hydraulic, electrical mechanical and pneumatic interlock switches which interact with standard linkages common to said gurney.

77. A drive module system according to claim 76 wherin said air pressure release valve controls the presence or absence of air pressure in the drive system.

78. A drive module system according to claim 76 wherin said electrical interlock switch controls the presence or absence of electrical power in the drive system depending upon the position of the gurney's brake pedal.

79. A drive module system according to claim 78 wherein said pneumatic and electrical circuitry provide routing for air pressure and electrical power, respectively.

80. A drive module system according to claim 79 wherein said actuating means is mounted on the gurney's brake pedal linkage for purposes of triggering said air pressure release valve and said electrical interlock switch when the gurney's brake pedal is depressed.

81. A drive unit chassis assembly comprising:
a structural frame;
a battery box;
and a motor controller assembly.

82. A drive unit chassis assembly according to claim 81 wherein said structural frame is made from a material selected from steel, aluminum, and carbon fiber.

83. A drive unit chassis assembly according to claim 81 wherein said structural frame is designed to fit on the chassis of existing gurneys, and be secured by mounting means including mechanical fasteners.

84. A drive unit chassis assembly according to claim 83 wherein said mounting means comprise a series of holes so located as to correspond to holes present in said existing gurney chassis.

85. A drive unit chassis assembly according to claim 81 wherein said battery box is made from a material selected from steel, aluminum, and carbon fiber, or other suitable material, and includes a cover of like material to protect the contents from damage by water or other foreign matter intrusion.

86. A drive unit chassis assembly according to claim 85 wherein said battery box is attached to said structural frame by means of welding, bonding, and/or mechanical fasteners.

87. A drive unit chassis assembly according to claim 81 wherein said motor controller assembly comprises a housing, electrical circuitry, and mounting means.

88. A drive unit chassis assembly according to claim 87 wherein said housing is made from a non conductive material selected from plastic, and carbon fiber.

89. A drive unit chassis assembly according to claim 88 wherein said housing protects said electrical circuitry from damage by water or other foreign matter inrusion, and protecting any persons who may otherwise come into contact with electrical circuitry.

90. A drive unit chassis assembly according to claim 87 wherein said electrical circuitry includes speed control throttles, and provides a variable voltage to said drive wheel, based on the position of said speed control throttles, resulting in gurney travel at variable speeds.

91. A drive unit chassis assembly according to claim 90 wherein said mounting means secure said motor controller assembly to said structural frame by means of mechanical fasteners.

92. A system for traversing irregular pathways comprising:
a drive wheel assembly;
a resilient air spring;
an air compressor;
a pressure switch; and
pivoting means of the drive module system.

93. A system for traversing irregular pathways according to claim 92 wherein said air spring contains a constant air pressure provided by said air compressor and regulated by said pressure switch.

94. A system for traversing irregular pathways according to claim 93 wherein said pressure switch recognizes a drop in air pressure inside said air spring when the drive wheel assembly begins to lose contact with the floor due to irregularities in the floor.

95. A system for traversing irregular pathways according to claim 94 wherein said pressure switch provides electrical power to said air compressor, which restores the preset air pressure to said air spring, causing it to expand farther, lowering said pivoting means down and forcing said drive wheel back into contact with the floor.

96. A system for traversing irregular pathways according to claim 95 wherein said pressure switch recognizes an increase in air pressure, and releases the excess, maintaining the preset pressure inside said air spring, and keeping said drive wheel from exerting too much force on the floor.
